(19) United States
(12) Patent Application Publication
(10) Pub. No.: US 2008/0150279 A1
(43) Pub. Date: Jun. 26, 2008

(54) Sealing of Pipe to Sump Interfaces

(75) Inventors: Richard Statham, Staffordshire (GB); Dennis O'Dea, Staffordshire (GB)

Correspondence Address: HESLIN ROTHENBERG FARLEY & MESITI PC, 5 COLUMBIA CIRCLE, ALBANY, NY, 12203, US

(73) Assignee: GLYNWED PIPE SYSTEMS LTD, Kent (GB)

(21) Appl. No.: 10/598,046

(22) PCT Filed: Feb. 16, 2005
(86) PCT No.: PCT/GB2005/099554

§ 371 Date: Dec. 20, 2007

(30) Foreign Application Priority Data
Feb. 17, 2004 (GB) 0403471.6

(51) Int. Cl. F16L 5/02; F16L 41/14; F16L 23/00

(52) U.S. Cl. 285/139.1; 285/215; 285/291.1

(57) ABSTRACT

A coupling assembly for sealing an interface between a pipe and a sump wall, the assembly comprising; a sleeve (21) configured to be inserted in an aperture in a sump wall (20) and having a bore suitable for receiving a collar (22), the sleeve (21) having in diametrical cross section along its inner surface one or more circumferentially arranged, longitudinally extending undulations (21a); a collar (22) configured to be received between the sleeve (21) and the pipe P, being fusible to the pipe P and having a stepped internal diameter (22a) for receiving a swaging bung (23), a swaging bung (23) configured to be received in the stepped portion (22a) of the internal diameter of the collar (22) and configured to receive a pipe P; at least one washer (24a, 24b) having a diameter sized to fit the outside diameter of the sleeve (21); and a quantity of matting (25) comprising a material which is leak tight bondable to the material of the sump wall (20).

The present invention relates to the sealing of pipe to sump interfaces, that is sealing the interface at the point of entry of a pipe into a sump.

One specific application of the invention is in the fitting of ground pipes to fuel dispensers, such as those found in roadside fuel station forecourts. It will be appreciated that the invention could be adopted to other fluid dispensing applications.

A typical fuel dispenser consists of an above ground and a below ground portion. One or more delivery pipes pass from below ground into an above ground housing. Typically, a flexible pipe is coupled to each delivery pipe and passes through an aperture of the housing. The flexible pipe is provided with a hand operated valve which can be opened to deliver fuel from the delivery pipe into the fuel tank of a vehicle. Below ground, the delivery pipes are coupled with underground supply pipes which supply fuel from a fuel reservoir. A sump is provided around the delivery pipes where they couple to the supply pipes. The sump contains any fuel or fuel vapour which may escape from the delivery pipes, flexible pipes or couplings between those pipes. Necessarily, the supply pipes need to pass through walls of the sump so as to be coupled with the delivery pipes.

It will be understood that for safety reasons and for protection of the surrounding environment, it is important that any interface between supply pipes and the walls of the sump through which they pass be sealed to prevent leakage of the fuel to the surrounding environment. In the prior art, seals have been provided in the form of rubber boots, gators or gaskets which line the aperture of the sump and receive the supply pipe. Whilst reasonably effective, such rubber seals are susceptible to corrosion and wear. Such seals are perishable and need to be replaced at periodic intervals.

The present invention aims to provide an improved sealing arrangement which is more reliable and more permanent than the rubber seals known from the prior art.

In accordance with a first aspect of the present invention, there is provided a coupling assembly for sealing an interface between a pipe and a sump wall, the assembly comprising;
a sleeve configured to be inserted in an aperture in a sump wall and having a bore suitable for receiving a collar;
a collar configured to be received between the sleeve and the pipe, being fusible with the pipe and having a stepped internal diameter for receiving a swaging bung,
a swaging bung configured to be received in the stepped portion of the internal diameter of the collar and configured to receive a pipe;
at least one flanged washer having a diameter sized to fit the outside diameter of the sleeve and comprising at least in part a material which is leak tight bondable to the material of the sump wall.

In a second aspect, the invention provides a method for sealing an interface between a pipe and a sump wall, the method comprising assembling the assembly of the first aspect into an aperture in a sump wall, inserting a pipe end through the assembled collar and swaging bung, fusing the collar to the pipe, and bonding the leak tight bondable material of the flanged washer to the sump wall and sleeve.

The sleeve desirably comprises a metal. Optionally, the sleeve has in diametrical cross section along its inner surface one or more circumferentially arranged, longitudinally extending undulations. Optionally the flanged washers comprise a metal washer element and a matting of leak tight bondable material which can be positioned over the washer and sleeve to form the flanged portion of the washer.

Alternatively, the flanged washer comprises a unitary piece of leak tight bondable material, for example a glass reinforced plastic. Optionally, when assembled, the washers may be welded, bonded or otherwise secured to the sleeve. Desirably a first washer may be secured to the sleeve prior to assembly. An optional second washer may be provided in a floating configuration so that it can be correctly positioned and secured in position on site. In the latter configuration, a mechanical locking device may be included to enable the positioning and securing of the floating washer. In one example, the outside diameter of the sleeve over which the flange is located may be provided with a threaded end onto which a complimentary flange nut may be screwed to tighten the flange against the tank wall.

Optionally, the assembly further includes one or more sealing O-rings configured to be received in a circumferential groove provided on an internal surface of the sleeve.

The assembly may comprise a pair of collars, one of the pair being insertable in each of two opposing ends of the sleeve. In such an arrangement, the stepped portions of the collars are arranged face to face and receive a common swaging bung between them.

Fusion of the collar to the pipe may be achieved by various means. In a preferred option, the collar comprises an electro-fusion wire embedded in a thermoplastic. When the collar is in place with the pipe inserted, an electrical current is applied directly to the electro-fusion wire causing local melting of the surrounding thermoplastic and adjacent outer surface of the pipe resulting, on cooling, in a fused interface between the collar and the pipe. It will be appreciated that the collar may, as an alternative include an induction heating coil embedded in a thermoplastic. An electric current can be induced in the coil from a second coil positioned around the coupling again resulting in local melting and fusion of the interface between the pipe and the collar. Other alternative fusion methods will no doubt occur to the skilled addressee without departing from the scope of the invention, these might include (but are not strictly limited to); socket fusion and ultrasonic welding.

In use, the collar is inserted in the sleeve with the stepped portion of the internal diameter substantially aligned with the undulations of the sleeve and the, O-ring and O-ring groove (where present). The bung is inserted in the stepped portion (or where two collars are present is sandwiched between the two collars which are inserted from opposite ends of the sleeve), and the assembled sleeve, collar(s) and bung are inserted in an aperture of a sump wall. A washer (if not already welded or bonded to the sleeve) is slipped over an end of the sleeve and pushed up against a surface of the sump wall. Optionally, the washer is then bonded or fastened to the sleeve. If there is a second washer, this is slipped over the opposing end of the sleeve and pushed up against an opposing surface of the sump wall. Desirably, the washers are bonded or fastened to the sump wall surface.

The assembly in place, a pipe end is inserted through the common bore of the bung and collar(s). When the bung is inserted, it compresses the O-ring (where present) optimising the seal between the sleeve and the collar(s) and promotes cold flow of the collar into the undulations of the sleeve. This results in an increase in the end load characteristics of the assembly providing improved support for the pipe. Where a two part flanged washer arrangement is used (for example, the metal washer plus matting arrangement mentioned above), when the pipe is in position, the pieces of leak tight bondable material which form the flange are laid over the washers and sleeve and onto the sump wall surface. Finally, the leak tight bondable material is bonded to the sump wall surface and sleeve thereby providing a leak tight interface between the sump wall and the pipe coupling.

A problem addressed by the invention is the inability for certain materials to be directly bonded to others. For example, a typical fuel supply pipe comprises an outer layer of polyethylene (PE), whilst the walls of a fuel dispenser sump may comprise a glass reinforced plastic (GRP). These two materials are incompatible in that there is known no reliable bonding agent which can secure one directly to the other. GRP can, however be bonded to itself and also to metal. Thus, by incorporating a coupling of material to which GRP can be bonded (for example a metal or a GRP) and applying the bondable material onto the GRP of the sump wall, a bonded, leak tight join can be provided.

By choosing an inert and hard wearing material for the flanged washer, the join can be made far less susceptible to corrosion and erosion than prior art rubber seal arrangements. The more rigid arrangement is also more resistant to movement of pipes and end loads. Thus, the assembly of the invention provides a join which is more effective at preventing leaks and has a longer life than prior art arrangements.

For the purposes of exemplification, some embodiments of the invention will now be further described with reference to the accompanying figures in which;

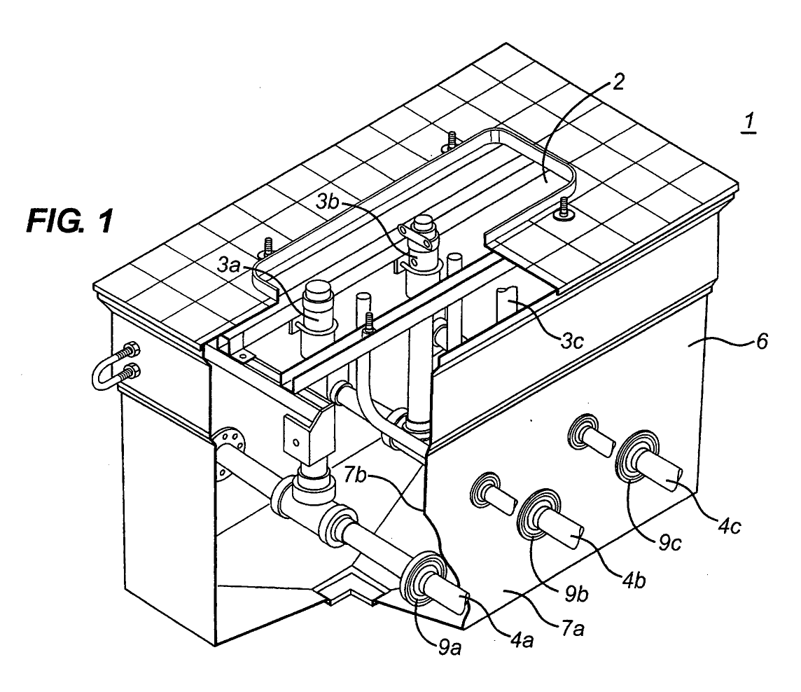

FIG. 1 illustrates in cut out section, a dispenser sump including supply and delivery pipes;

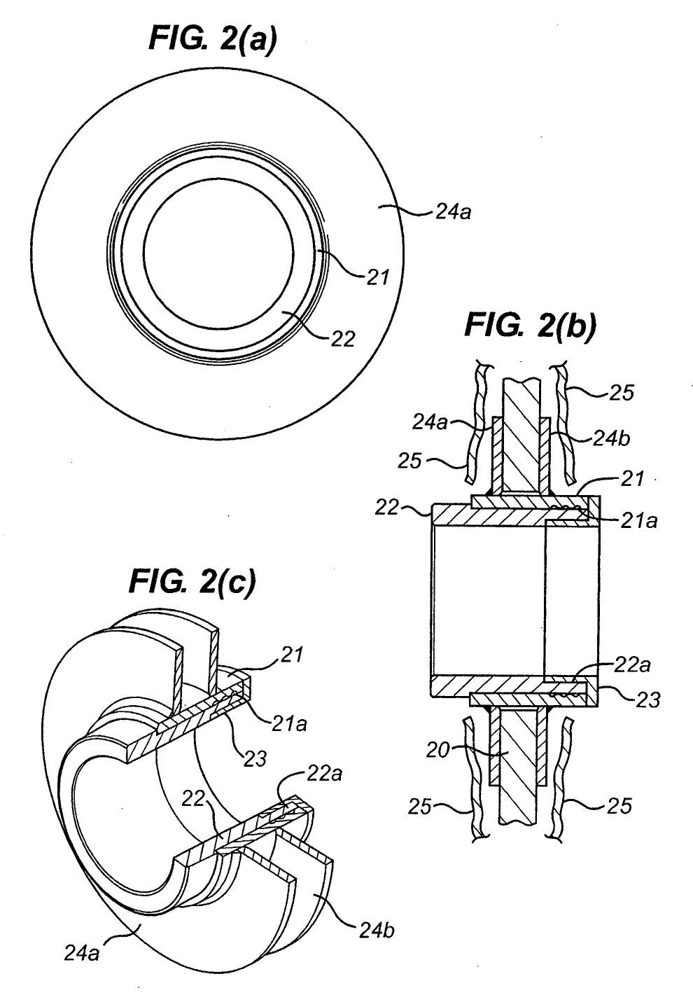

FIGS. 2a), b) and c) show three views of the inner components of a first embodiment of an assembly in accordance with the invention;

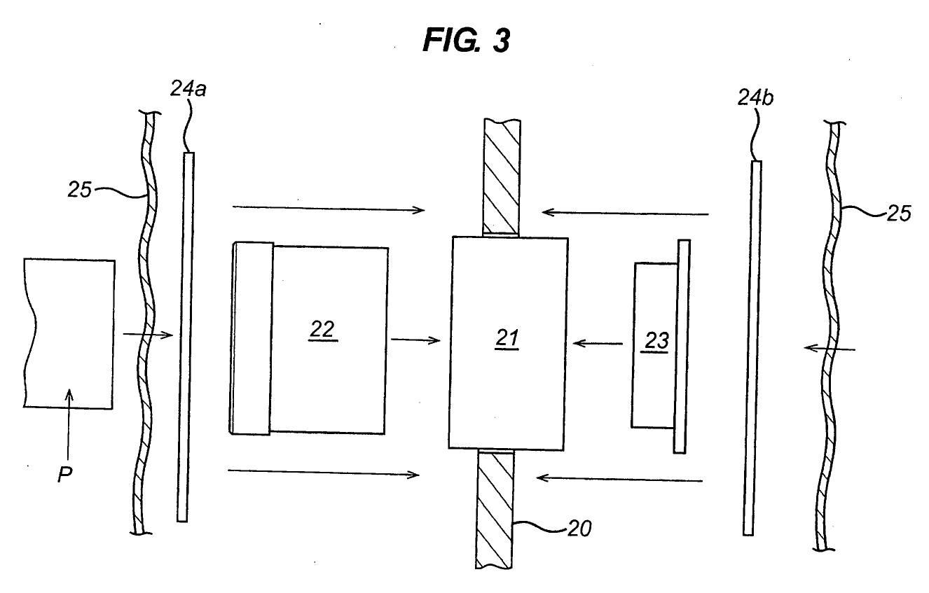

FIG. 3 illustrates in exploded form the assembly of FIG. 2;

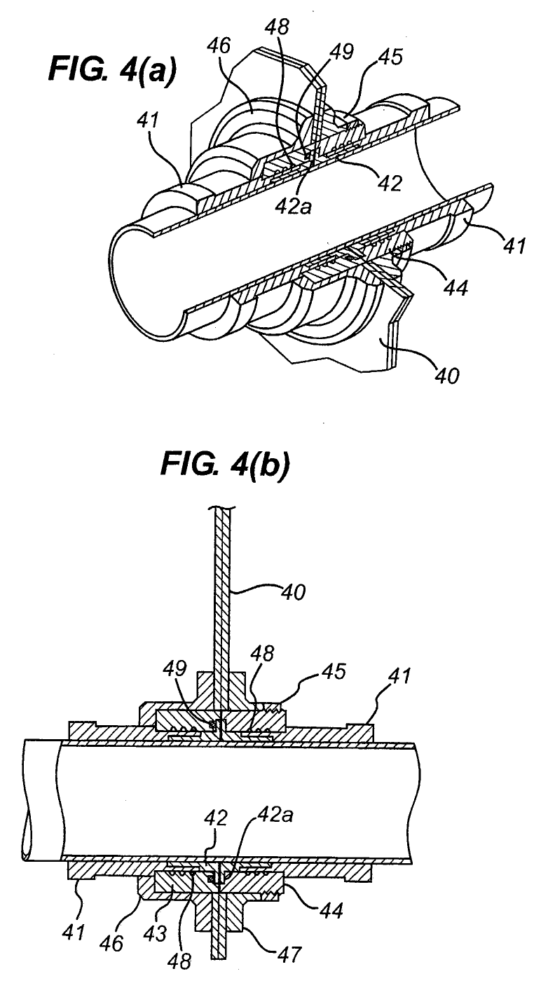

FIGS. 4a) and b) show an isometric cutaway and vertical section through a second embodiment of an assembly in accordance with the invention.

As can be seen from FIG. 1 a typical dispenser sump comprises a large, deep container, 1 having an opening 2 in a top surface to allow passage of delivery pipes 3a, 3b, 3c and also to allow collection of fluids which may leak from pipe work. A plurality of supply pipes 4a, 4b, 4c pass through apertures in a wall 6 of the sump container 1 to join with the delivery pipes 3a, 3b, 3c. Each aperture is sealed by a flanged rubber seal 9a, 9b, 9c which has a body sized to fit the aperture and includes a bore through which the supply pipe passes. The flanges of the seal extend radially outwardly from the aperture across front and rear faces 7a, 7b of the sump wall 6.

FIG. 2a) shows an end view of an assembled assembly in accordance with a first embodiment of the invention. The embodiment includes a two part flanged washer arrangement comprising a metal washer 24a, 24b) and a matting 25 of leak tight bondable material which can be swathed over the washer, sleeve and sump wall. In FIG. 2a) the matting is excluded for clarity. FIG. 2b) shows a diametrical cross section through the assembly of FIG. 2a). FIG. 2c) shows an isometric cutaway view of the assembly of FIGS. 2a) and 2b).

As can be seen from the Figures, the assembly comprises an outer sleeve 21 which, on an inner surface has an undulated surface 21a. A collar 22 is received in the sleeve 21. The internal diameter of the collar 22 is stepped 22a at the end adjacent the undulated surface 21a of the outer sleeve 21. A swaging bung 23 is received in the stepped portion 22a. Slippable over the outer sleeve 21 are a pair of washers 24a, 24b. In FIG. 2b) the assembly is shown fitted through an aperture in a wall 20 of a sump. Layers of matting 25 are, in use, laid over the washers 24a, 24b, the sleeve 22 and sump wall 20 and bonded thereto.

FIG. 3 shows schematically an explosion of the assembly prior to fitting in an aperture in a sump wall 20 and insertion of a pipe P in the assembly. Working from the left to the right of the picture, the arrows show the direction in which the component parts are to be assembled.

As can be seen from FIGS. 4a) and 4b) this second embodiment of the assembly of the invention comprises a pair of collars 41 inserted in a sleeve 43, 44. It can be seen the collars each have a stepped internal diameter similar to that seen in first embodiment. The larger internal diameter ends of the two collars face each other. Between the two collars 41 and within the stepped diameter portion of each is arranged an annular bung 42. The bung 42 includes a centrally arranged circumferential protrusion 42a which sandwiches between two sleeve halves 43, 44 and is aligned with the tank wall 40. Each of sleeve halves 43 and 44 include circumferential undulations into which the collar can plastically flow when the pipe is inserted and circumferential grooves into which an O-ring 48 is located. An additional O ring 49 is sited in a small annular recess provided in a radially extending surface of the circumferential recess 42a of the bung 42. A fixed flange 46, typically of GRP composite material surrounds the sleeve halve 43 and abuts the tank wall 40 as well as the collar 41. The flange 46 may be pre-bonded to the sleeve halve 43 and optionally the collar 41 prior to assembly. Once in the assembled position, the flange is bonded to the tank wall 40. This bonding may be facilitated by the provision of a surface coating or impregnation of bonding agent on the flange 46, which agent is curable on site to bond to the tank wall.

A second, free floating flange 47 surrounds the second sleeve half 44. The sleeve half is provided with a circumferential thread adjacent its exposed end onto which a flange nut 45 can be screwed so as to force the flange 47 up against the tank wall surface. This can assist in bonding of the flange to the tank wall surface, for example by means of a pressure sensitive bonding agent.

It is to be understood that the previously described embodiments are examples of just some embodiments which the invention may take and are not intended to be limiting of the true scope of the invention as claimed in the appended claims.

1. A coupling assembly for sealing an interface between a pipe and a sump wall, the assembly comprising;
a sleeve configured to be inserted in an aperture in a sump wall and having a bore suitable for receiving a collar;
a collar configured to be received between the sleeve and the pipe, being fusible with the pipe and having a stepped internal diameter for receiving a swaging bung,
a swaging bung configured to be received in the stepped portion of the internal diameter of the collar and configured to receive a pipe;
at least one flanged washer having a diameter sized to fit the outside diameter of the sleeve and comprising at least in part a material which is leak tight bondable to the material of the sump wall.

2. A coupling assembly as claimed in claim 1 wherein the sleeve comprises a metal.

3. A coupling assembly as claimed in claim 1 or 2 wherein the sleeve has in diametrical cross section along its inner surface one or more circumferentially arranged, longitudinally extending undulations.

4. A coupling assembly as claimed in claim 1 wherein the flanged washer comprises a metal washer element and a matting of leak tight bondable material which can be positioned over the washer and sleeve to form the flanged portion of the washer.

5. A coupling assembly as claimed in claim 1 wherein the flanged washer comprises a unitary piece of leak tight bondable material.

6. A coupling assembly as claimed in claim 1 further comprising an O-ring seated in an O-ring groove provided on an inner surface of the sleeve.

7. A coupling assembly as claimed in claim 1 wherein the collar comprises a thermoplastic material.

8. A coupling assembly as claimed in claim 7 wherein the collar further includes an electro-fusion wire embedded in the thermoplastic material.

9. A coupling assembly as claimed in claim 7 wherein the collar further includes an induction heating coil embedded in the thermoplastic material.

10. A coupling assembly as claimed in claim 4 wherein the leak proof bondable material comprises the same material as a sump to which it is intended to be bonded.

11. A coupling assembly as claimed in claim 4 wherein the leak proof bondable material comprises a fibre reinforced plastic, optionally a glass reinforced plastic (GRP).

12. A coupling assembly as claimed in claim 4 wherein the leak proof bondable material is impregnated or coated with a bonding resin.

13. A coupling assembly as claimed in claim 1 including two flanged washers.

14. A coupling assembly as claimed in claim 13 wherein the second washer is provided in a floating configuration so that it can be correctly positioned and secured in position on site.

15. A coupling assembly as claimed in claim 14 wherein the second washer has associated therewith a mechanical locking device.

16. A coupling assembly as claimed in claim 15 wherein the mechanical locking device comprises a thread on the outer diameter of the sleeve and a complimentary flange nut for screwing onto the flange.

17. A coupling assembly as claimed in claim 1 wherein the assembly comprises a pair of collars, one of the pair being insertable in each of two opposing ends of the sleeve with the stepped portions of the collars arranged face to face and a common swaging bung configured to fit between the two collars.

18. (canceled)

19. (canceled)

20. A method for sealing an interface between a pipe and a sump wall comprising;
providing a coupling assembly as claimed in any preceding claim;
inserting the sleeve through an aperture of the sump;
inserting the collar(s) into the sleeve from the end furthest from the undulations;
inserting the bung into the stepped portion(s);
slipping the or each flanged washer over the sleeve to rest against a surface of a wall of the sump;
inserting the pipe through the collar and bung;
fusing the collar to the pipe; and
bonding the leak proof bondable material to the exposed surfaces of the assembled coupling and wall of the sump.

21. A method as claimed in claim 20 wherein at least one washer is welded or leak tight bonded to the sleeve.

22. A method as claimed in claim 20 or 21 wherein the collar includes an electro-fusion wire and the step of fusing the collar to the pipe involves energising the electro-fusion wire with an electrical current sufficient to cause local melting and fusion at the pipe/collar interface.

23. A method as claimed in claim 20 or 21 wherein the collar includes an induction heating element and the step of fusing the collar to the pipe involves inducing an electric current in the induction heating element sufficient to cause local melting and fusion at the pipe/collar interface.

24. A method as claimed in claim 21 wherein the fusion step involves sonic welding or socket fusion.
